(19) United States
(12) Patent Application Publication
(10) Pub. No.: US 2003/0069835 A1
(43) Pub. Date: Apr. 10, 2003

(54) Data processing system for conducting on-line auction

(76) Inventor: Yomei Tsuno, Yokohama (JP)

Correspondence Address: MCDERMOTT, WILL & EMERY, 600 13th Street, N.W., Washington, DC, 20005-3096, US

(21) Appl. No.: 10/232,827

(22) Filed: Sep. 3, 2002

(30) Foreign Application Priority Data
Oct. 9, 2001 (JP) 2001-311451

(51) Int. Cl. G06F 17/60

(52) U.S. Cl. 705/37

(57) ABSTRACT

In a trade mediating mechanism computer for use in a trade mediating system for making a contact of trade of an article between individuals through a network, a page for trade mediation is generated and managed by utilizing an article registration database (DB) and a user DB. By utilizing an electronic ticket DB, management, issue, authentication, and collection of an electronic ticket is carried out. When a sales contract is settled, electronic tickets including discount information are issued to an exhibitor terminal and a bidder terminal. When receiving a check authentication request of the electronic ticket from a banking organ computer or a transportation mechanism computer, the trade mediating mechanism computer authenticates the electronic ticket and returns an authentication result.

### BACKGROUND OF THE INVENTION

The present invention relates to discount service in a trade mediating system such as an auction or trade information billboard system using a network.

The trade information billboard system or the auction system has been well-known as a scheme for mediating purchase and sale of an article between individuals. In these systems, for making payment of a fee of the article or payment of a carriage fee for the article, it has been practiced that a payer pays the fee directly into an account at a bank designated by a charge payee or the payer disburses the fee through a network by using an account number of a credit card of the payer. In this case, when a bank designated by the charge payee differs from a bank with which the payer contracts or in the event that the credit card is unusable, the paying-in cannot sometimes fulfill itself or consumes much time or superfluous costs are sometimes involved including traffic expenses necessary for taking procedures or a commission such as a fee for payment into the account.

In forwarding articles, giving service of reduction of the charge on the basis of a contract has hitherto been known between an enterprise that sends an order for forwarding of a large amount of articles and a door-to-door courier service dealer but service of reduction of the forwarding charge urged by an individual sender on a door-to-door courier service dealer has not hitherto been known. Incidentally, most of users of the trade mediating system are individuals and the individuals are burdened relatively largely with charges for forwarding articles. Accordingly, by introducing the reduction service to these charges, remarkable effects are to be expected in increasing the number of users of the trade mediating system.

Giving various kinds of service in the trade mediating system using the network is known as will be described below.

JP-A-11-134408 describes an electronic shopping system. The electronic shopping system is provided with means for giving additional service in accordance with an article of trade to be purchased by a client in an on-line shopping. In the system, discount service for a purchase money amount and presentation of service card or coupon card are available as the additional service but the usable range is limited to shops in an electronic shopping district and the additional service is given to purchasers only.

JP-A-10-269447 describes delivery service in an on-line shopping system. In the on-line shopping system, there is provided means for enabling a user of service to select desired delivery service by taking conditions such as time required for delivery and costs into account.

JP-11-213068 describes an electronic ticket system for conducting a transaction by using an electronic ticket storing specified service information. In the system, there is provided, in addition to an electronic ticket issue organ computer and a service offer organ computer, an electronic ticket collection organ computer and it is decided in the electronic ticket collection organ computer whether a collected electronic ticket is an authorized one or not. By virtue of this, the system can be a safe system in which even in the event that an electronic ticket is copied without authorization, the electronic ticket can be prevented from being used for payment of a fee for different service or payment to a different account.

### SUMMARY OF THE INVENTION

Incidentally, the electronic shopping system of JP-A-11-134408 fails to consider any service offer to an article exhibitor and the on-line shopping system of JP-A-10-269447 and electronic ticket system of JP-A11-213068 do not consider reduction service based on a use frequency or a total use money amount by a service user in the system and reduction service for a delivery fee. Further, a door-to-door courier service dealer sometimes offers, to an enterprise, outsourcing goods such as agency service including marketing and acceptance of an order, physical distribution and bill settlement based on a database but such goods are not sufficiently considered in the transaction between individuals.

As described above, when a sales contract for an article is made between an exhibitor and a bidder and thereafter payment of a bill of the article and reception of the article are carried out, the conventional trade mediating system consumes much time and costs superfluous expenses such as transporting expenses and a fee for payment into an account and besides, it fails to disclose reduction service given to the exhibitor and bidder in accordance with the use frequency and total use money amount.

The present invention contemplates elimination of the above problems and has its object to provide additional or extra service such as a discount that does not cost both the exhibitor and bidder any superfluous expenses and besides complies with the use frequency and total use money amount.

To solve the above problems, the present invention adopts the following means.

In a trade mediating mechanism computer 1 for use in a trade mediating system for making a contract of trade of an article between individuals through a network, the trade mediating mechanism computer 1 comprises page generation and management means 12 for generating and managing a page for trade mediation by utilizing an article registration database (DB) 14 and a user DB 15 and electronic ticket management/issue/collection means 13 for performing management/issue/authentication/collection of an electronic ticket by utilizing an electronic ticket DB 16, wherein the trade mediating mechanism computer issues electronic tickets 34 and 44 inclusive of discount information to an exhibitor terminal 3 and a bidder terminal 4 when a sales contract is settled, and when receiving a check 308 of electronic ticket 44 or a check 313 of electronic ticket 34 from a banking organ computer 5 or a transportation mechanism computer 6, the trade mediating mechanism computer causes the electronic ticket management/issue/collection means 13 to authenticate the electronic ticket and returns an authentication result.

### BRIEF DESCRIPTION OF THE DRAWINGS

FIG. 1 is a diagram showing the overall construction of a trade mediating system of the invention.

FIG. 2 is a diagram showing details of the FIG. 1 overall construction.

FIG. 3 is a time chart showing the flow of information in the trade mediating system of the invention.

FIG. 4 is a diagram showing an embodiment of system utilization by an IC card at a banking organ computer 5 of the invention.

FIG. 5 is a diagram showing an embodiment of system utilization by an IC card at a transportation mechanism computer 6 of the invention.

FIG. 6 is a diagram showing the flow of an electronic ticket in connection with article fee and forwarding fee and an example of data of an electronic ticket of a bidder in the invention.

FIG. 7 is a diagram showing the flow of an electronic ticket in connection with forwarding of an article and an example of data of an electronic ticket of an exhibitor in the invention.

FIG. 8 is a diagram showing an example of data of electronic ticket information accumulated in an electronic ticket DB 16 annexed to the trade mediating mechanism computer 1 of the invention.

FIG. 9A is a graph showing a discount service rate in accordance with the past use frequency in the trade mediating system of the invention.

FIG. 9B is a graph showing a discount service rate in accordance with the transaction money amount in the trade mediating system of the invention.

### DESCRIPTION OF THE EMBODIMENTS

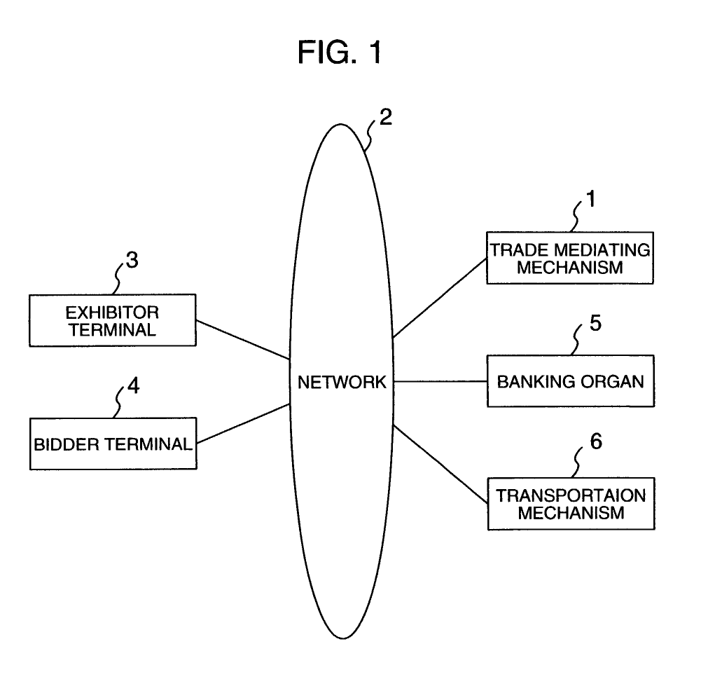

Embodiments of the invention will now be described with reference to FIGS. 1 to 9.

Referring first to FIG. 1, there is illustrated the overall construction of a trade mediating system of the invention.

A trade mediating mechanism computer 1 offers a trade mediating system between individuals such as an auction or trade information billboard system to an exhibitor terminal 3 or a bidder terminal 4 through a network 2. A banking organ computer 5 offers a so-called network banking function such as payment of money into an account through the network 2. A transportation mechanism computer 6 offers service on the network 2 by a door-to-door courier service dealer, for instance.

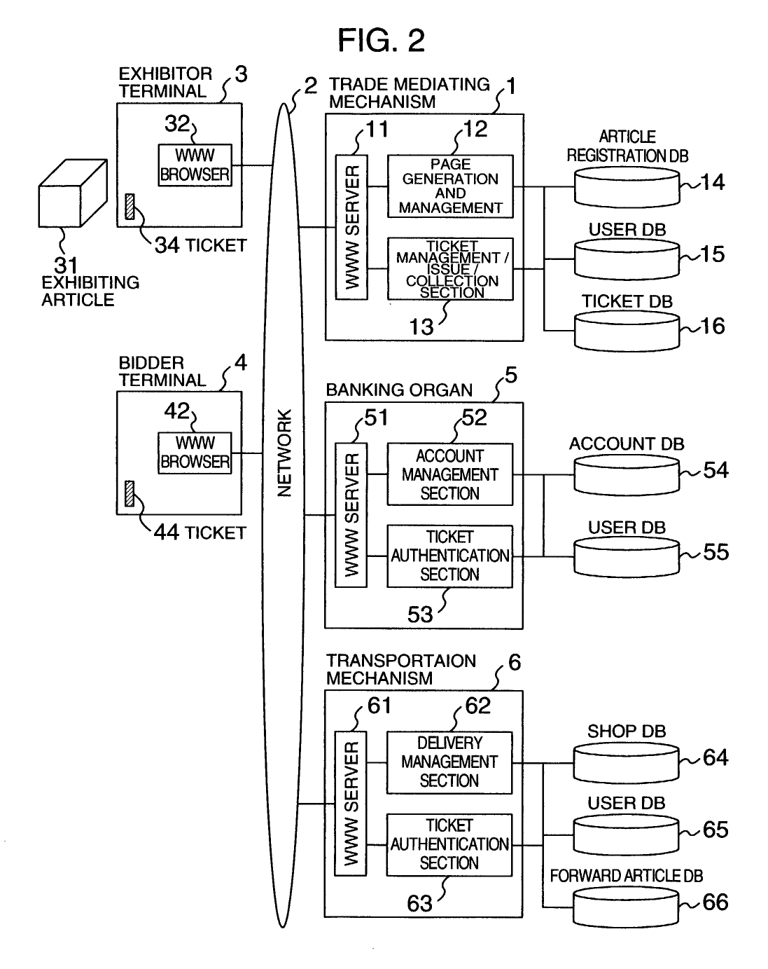

FIG. 2 shows details of the overall construction of the trade mediating system of the invention.

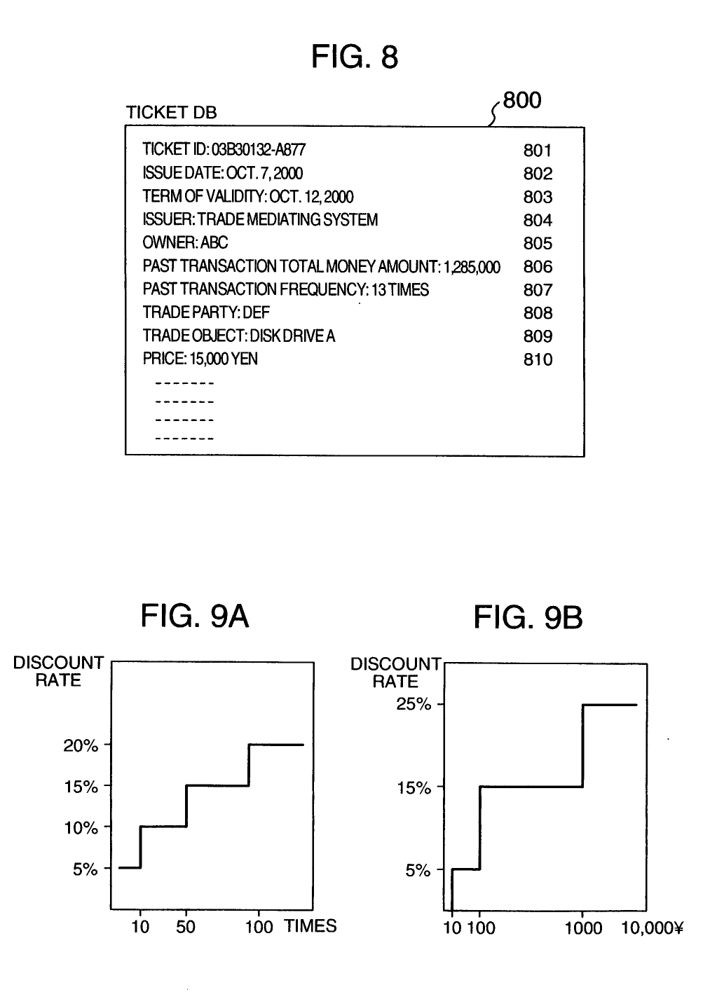

The trade mediating mechanism computer 1 includes a www server 11, page generation and management means 12 and electronic ticket management/issue/collection means 13 and it is annexed with an article registration DB 14 for registering articles to be mediated for trading, a user DB 15 for registering users of the trade mediating system and an electronic ticket DB 16 (see FIG. 8) for storing data of electronic tickets used in the trade mediating system. The trade mediating mechanism computer 1 causes the www server 11 to offer a trade mediating system to a user through the network 2. The page generation and management means 12 generates and manages a page for trade mediation by utilizing the article registration DB 14 for registering articles mediated for trade and the user DB 15 registering trade mediating system users. The electronic ticket management/issue/collection means 13 utilizes the electronic ticket DB 16 to perform management/issue/authentication/collection of an electronic ticket.

The banking organ computer 5 causes account management means 52 to offer banking service such as paying-in, transfer or balance reference by using an account DB 54 and a user DB 55 and causes electronic ticket authentication means 53 to take charge of authentication as to whether an electronically presented electronic ticket is legal.

The transportation mechanism computer 6 causes delivery management means 62 to offer service such as reservation of reception of article delivery and transportation by using a shop DB 64, a user DB 65 and a forwarding article DB 66 and causes electronic authentication means 63 to take charge in authentication as to whether an electronically presented electronic ticket is legal.

The exhibitor terminal 3 is a terminal capable of utilizing various kinds of service on the network 2 by the aid of a www browser 32 and saves, in a memory device inside the exhibitor terminal 3, an electronic ticket 34 issued from the trade mediating mechanism computer 1 when an exhibiting article 31 is sold by utilizing the trade mediating mechanism computer 1.

Similarly, the bidder terminal 4 is also a terminal capable of utilizing various kinds of service on the network 2 by the aid of a www browser 42 and saves, in a memory device inside the bidder terminal 4, an electronic ticket 44 issued from the trade mediating mechanism computer 1 when a successful bid is made for an article (exhibiting article 31) by utilizing the trade mediating mechanism computer 1.

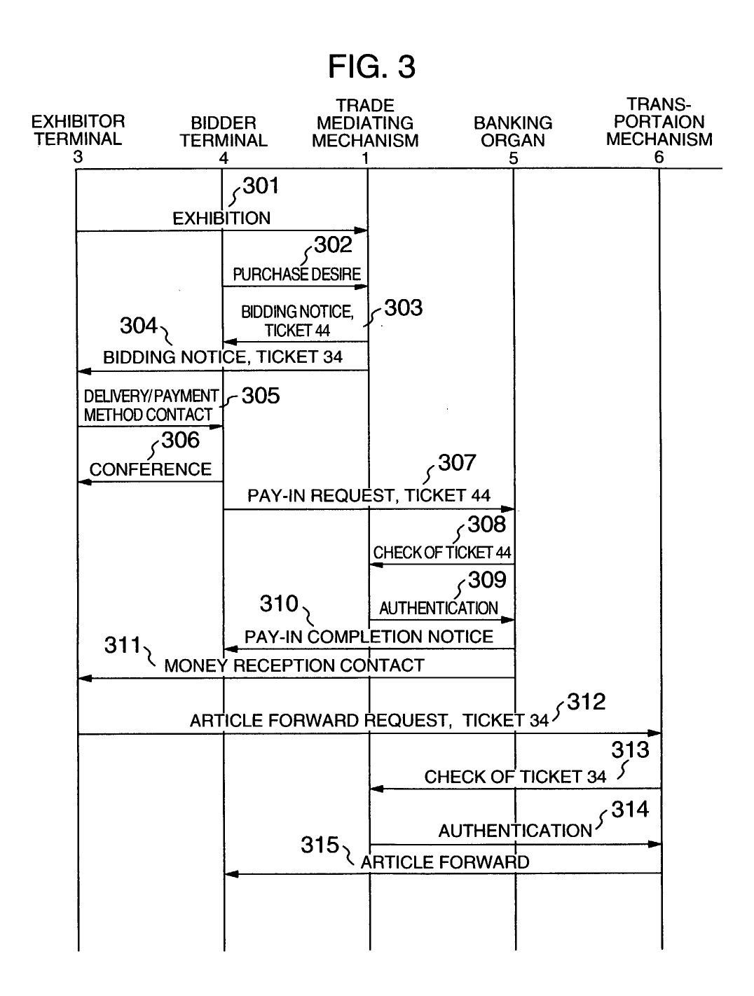

Next, operation of the trade mediating system constructed as shown in FIGS. 1 and 2 will be described. FIG. 3 depicts a specified example of a time chart showing the flow of information in the trade mediating system of the invention. In this example, after a bidder has paid a charge, an exhibitor sends out an exhibiting article.

The exhibitor uses the exhibitor terminal 3 to send, as exhibition 301, information concerning an exhibiting article 31 such as image and price of the exhibiting article 31 and an auction period to the trade mediating mechanism computer 1. The bidder uses the bidder terminal 4 to send, as purchase desire 302, information concerning bidding such as a price for making a successful bid for the exhibiting article 31. The trade mediating mechanism computer 1 conducts an auction of the exhibiting article 31 and when the auction ends, sends an auction notice 303 added with an electronic ticket 44 to the bidder terminal 4. Concurrently, the computer 1 sends a notice 304 informing the conducted bidding and added with an electronic ticket 34 to the exhibitor terminal 3. Then, a contact 305 concerning a method for delivery/reception of the exhibiting article 31 and payment and a conference 306 therefor are carried out between the exhibitor and bidder by using the exhibitor terminal 3 and bidder terminal 4 as well as other communication means, so that a concrete method for delivery/reception and payment is settled between the two parties.

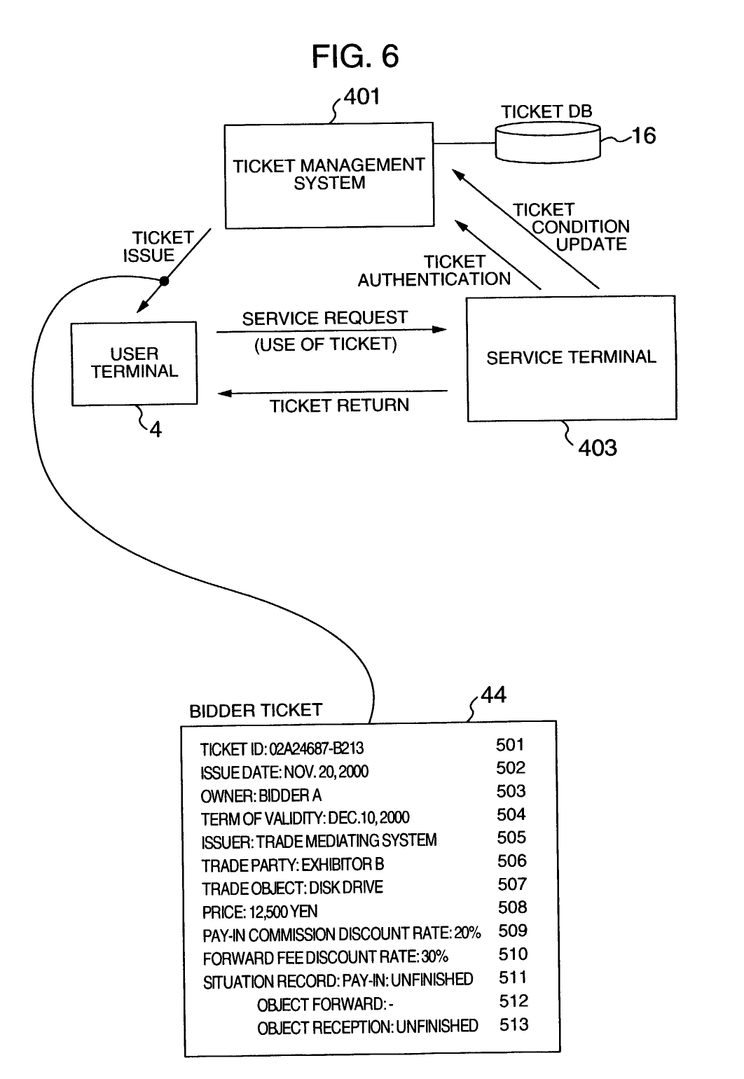

The bidder uses the bidder terminal 4 to ask the banking organ computer 5 for paying-in by adding the electronic ticket 44 to paying-in request 307 a bill of the exhibiting article 31. The banking organ computer 5 sends check information for the electronic ticket 44, as a check 308, to the trade mediating mechanism computer 1 with the aim of authenticating the received electronic ticket 44. The trade mediating mechanism computer 1 causes the electronic ticket management/issue/collection means 13 to authenticate the electronic ticket 44 and returns authentication 309 to the banking organ computer 5. The banking organ computer 5 withdraws a bill of the exhibiting article 31 (including a carriage) and a commission from an account of the bidder and pays the bill of the exhibiting article 31 into an account of the exhibitor. A discount rate according to information of electronic ticket 44 (see FIG. 6) is applied to the paying-in money. This discount rate has been registered in a discount rate table possessed by the electronic ticket management/issue/collection means 13 of trade mediating mechanism computer 1. Then, the banking organ computer sends a contact 311 of receipt of money and a notice 310 of paying-in completion to the exhibitor terminal 3 and the bidder terminal 4, respectively.

Subsequently, the exhibitor uses the exhibitor terminal 3 to send an article forward request 312 of the exhibiting article 31, together with the electronic ticket 34, to the transportation mechanism computer 6. For authentication of the received electronic ticket 34, the transportation mechanism computer 6 sends the ticket information of electronic ticket 34, as a check 313, to the trade mediating mechanism computer 1. The trade mediating mechanism computer 1 causes the electronic ticket management/issue/collection means 13 to authenticate the electronic ticket and returns authentication 314 to the transportation mechanism computer 6. The transportation mechanism computer 6 accepts the delivery of the exhibiting article 31 and collects a fee applied with a discount rate, as a delivery fee, from the exhibitor 301. Then, the computer 6 sends, as article forwarding 315, a notice purporting that the delivery of exhibiting article 31 is arranged and information such as a forward date, a scheduled delivery date and the like to the bidder terminal 4.

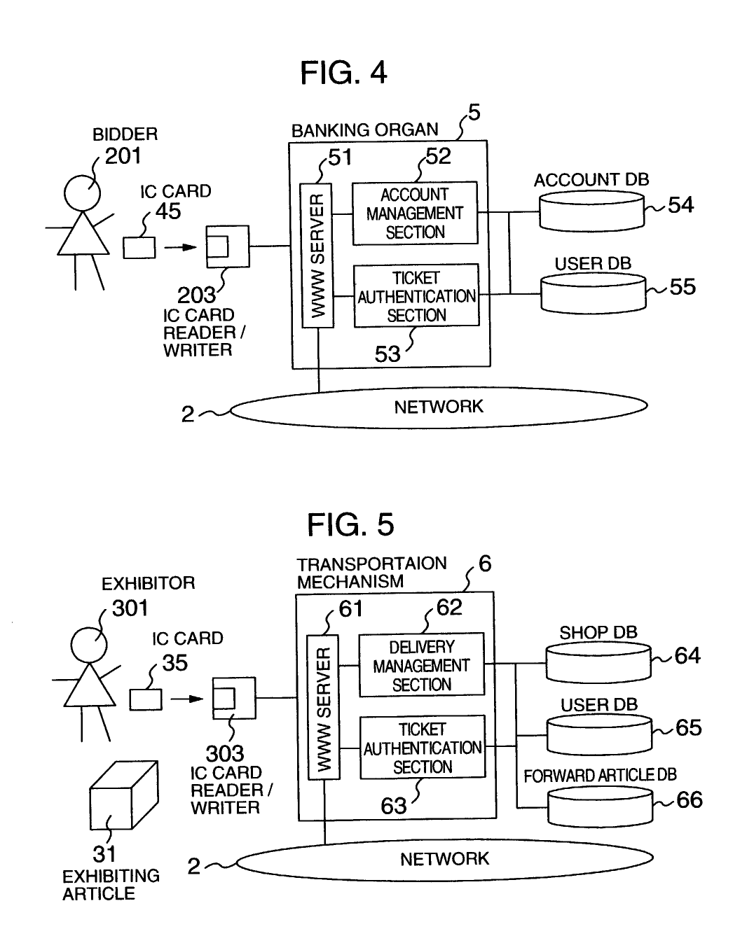

Referring now to FIG. 4, there is illustrated an embodiment of system utilization by an IC card at the banking organ computer 5 of the invention. In the example of FIG. 3, the bill settlement is carried out by using the network but in FIG. 4, an instance will be described in which a bidder goes to a counter of a banking organ to carry out paying-in of a bill. A bidder 201 copies an electronic ticket 44 inside the bidder terminal 4 on an IC card 45 and thereafter goes to the counter of the banking organ while carrying the IC card 45 to make a request for paying-in. The banking organ computer 5 uses an IC card reader/writer 203 to read information of the electronic ticket 44 stored in the IC card 45. Subsequently, the banking organ computer 5 causes the electronic ticket authentication means 53 to send, as a check 308, check information of electronic ticket 44 to the trade mediating mechanism computer 1 and the computer 1 causes the electronic ticket management/issue/collection means 13 to authenticate the electronic ticket 44 so as to recover authentication 309 and confirm the authentication 309 to certify the validity of the information of electronic ticket 44. After certifying the validity of the electronic ticket 44, the banking organ computer 5 causes the account management means 52 to pay the bill of the article into the account of the exhibitor. A discount rate according to the information of electronic ticket 44 is applied to the paying-in fee.

Referring to FIG. 5, there is illustrated an embodiment of system utilization by an IC card at the transportation mechanism computer 6 of the invention. In the example of FIG. 3, a request for forwarding an article is made by using the network but in FIG. 5, an instance will be described in which an exhibitor goes to a door-to-door courier service reception counter of a carrier and makes a request for forwarding an article. An exhibitor 301 copies an electronic ticket 34 inside the exhibitor terminal 3 on an IC card 35 and thereafter goes to the door-to-door courier service reception counter while carrying the IC card 35 and an exhibiting article 31. The transportation mechanism computer 6 causes an IC card reader/writer 303 to read information of the electronic ticket 34 stored in the IC card 35. Subsequently, the transportation mechanism computer 6 causes the electronic ticket authentication means 63 to send, as a check 313, check information of the electronic ticket 34 to the trade mediating mechanism computer 1 and the computer 1 causes the electronic ticket management/issue/collection means 13 to authenticate the electronic ticket 34 so as to recover authentication 314 and confirm the authentication 314 to certify the validity of the information of electronic ticket 34. Then, the delivery management means 62 is used to receive forwarding of the exhibiting article 31 and collect, as a forwarding fee, a carriage applied with a reduction rate from the exhibitor 301.

FIG. 6 shows the flow of an electronic ticket for article fee and forwarding fee and an example of data of an electronic ticket of the bidder.

When a bidding is settled in the trade mediating system, an electronic ticket management system 401 inside the electronic ticket management/issue/collection means 13 of trade mediating mechanism computer 1 issues an electronic ticket 44 for bidder to the bidder terminal 4. A bidder uses the bidder terminal 4 to pay a fee of an article for which a bid is made into a service terminal 403 of the banking organ computer 5 by inputting a paying-in party and a paying-in fee through the use of the electronic ticket 44. In the example of FIG. 6, in situation record in the electronic ticket 44 for the bidder, paying-in column 511 is recorded as “unfinished” to indicate a condition in which paying-in of the fee has not yet been executed. The service terminal 403 of the banking organ computer 5 sends the information of electronic ticket 44 to the electronic ticket management system 401 to cause it collate information of electronic ticket DB 16 with the information of electronic ticket 44 so as to verify whether the fee of the article designated by the bidder terminal 4 and the paying-in party are coincident with the contents of price column 508 (12500 yen) and the contents of trade party column 506 (exhibitor B) and return a verification result to the service terminal 403. Then, the service terminal 403 confirms the verification result. Subsequently, the service terminal 403 reduces the paying-in commission in accordance with a discount rate (20%) of paying-in commission discount rate column 509 and withdraws the paying-in commission along with the fee of the article from an account opened by the bidder A in bidder column 503. Then, a paying-in date is inputted to the paying-in column 511 of situation record in the electronic ticket 44. At the same time, the paying-in completion is also communicated to the electronic ticket management system 401 and the paying-in column of situation record in the information of electronic ticket corresponding to the electronic ticket 44 on the electronic ticket DB 16 is rewritten from “unfinished” to “finished”.

If the bidder inputs data by using the electronic ticket 44 in such a manner that payment into an account of a person other than the trade party 506 (exhibitor B) is made or a money amount non-coincident with the price 508 (12500 yen) is paid in, the service terminal 403 can give an alarm to advise the bidder terminal 4 that an paying-in operation non-coincident with the electronic ticket is about to be done. In a paying-in request non-coincident with the contents of the electronic ticket 44, the service terminal 403 conducts an ordinary paying-in operation and obviously, the reduction rate of paying-in commission is not applied. Similarly, when a paying-in operation is conducted again by using the electronic ticket 44, information concerning a paying-in date, which has already been entered in the paying-in column 511 of situation record in the electronic ticket 44, is used to inform the user that the paying-in has already been finished or the electronic ticket has already been used.

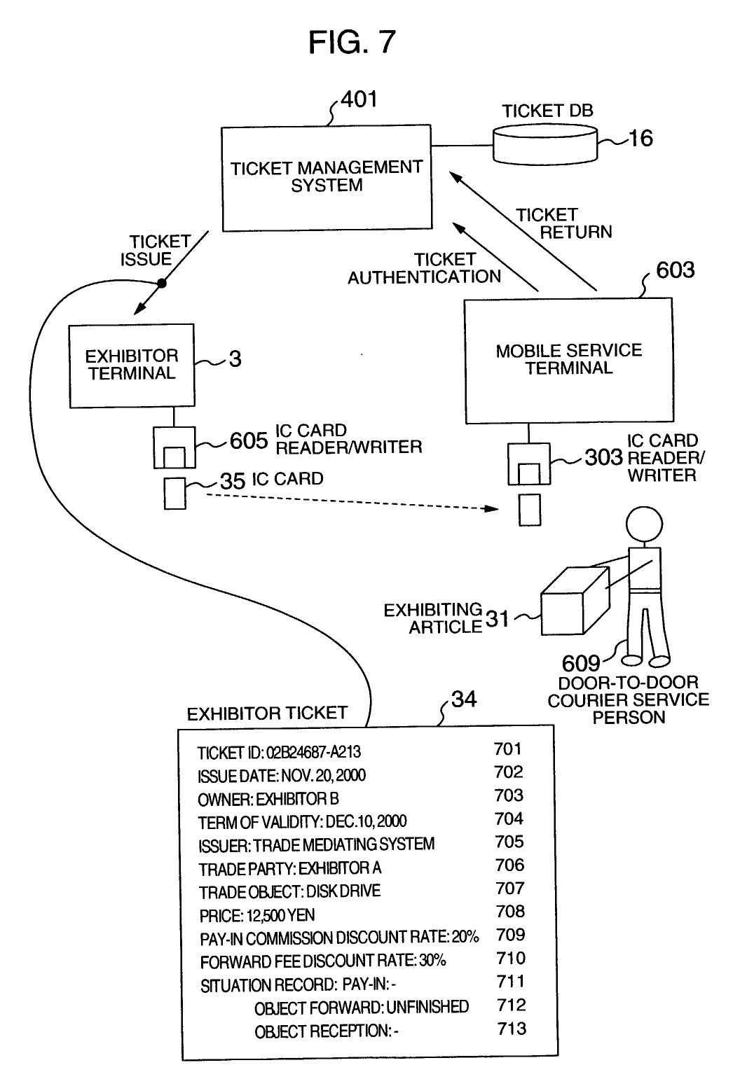

FIG. 7 shows the flow of an electronic ticket in forwarding of an article and an example of data in an electronic ticket of the exhibitor. FIG. 7 illustrates an instance in which a portable mobile service terminal 603 is used as the transportation mechanism computer 6 and a door-to-door courier service person goes to a dwelling of an exhibitor so as to receive an exhibiting article 31 while carrying the mobile service terminal 603.

When a bidding is settled in the trade mediating system, the electronic ticket management system 401 electrically transmits an electronic ticket 34 for exhibitor to the exhibitor terminal 3. The exhibitor records the electronic ticket 34 on an IC card 35 by using an IC card reader/writer 605. Thereafter, when a door-to-door courier service person 609 comes to receive the exhibiting article 31, the exhibitor allows the IC card 35 recording the electronic ticket 34 to be read by an IC card reader/writer 303 of the mobile service terminal 603 in order that information of the electronic ticket 34 for exhibitor can be inputted to the mobile service terminal 603. The mobile service terminal 603 sends the information of the electronic ticket 34 to the electronic ticket management system 401. Then, the electronic ticket management system 401 retrieves information registered in the electronic ticket DB 16 by using an electronic ticket ID 701 as key to collate the retrieved information with the information of the electronic ticket 34, thus authenticating the electronic ticket 34. If coincidence of the information of the electronic ticket 34 is confirmed, the electronic ticket 34 is certified as valid and an authentication result is returned to the mobile service terminal 603.

After confirming the authentication result, the door-to-door courier service person 609 measures weight and size of the exhibiting article 31 and inputs the data to the mobile service terminal 603. After determining that “unfinished” is written in object forwarding column 712 of situation record in the electronic ticket 34 for exhibitor, the mobile service terminal 603 calculates the carriage for the exhibiting article 31 on the basis of the data. During the calculation, the carriage is reduced at a rate (30%) of carriage discount rate column 710 and a reduced charge is displayed. The door-to-door courier service person 609 demands the exhibitor the carriage charge. Further, the mobile service terminal 603 returns the electronic ticket 34 to the electronic ticket management system 401. The return of the electronic ticket 34 can be done by electrically transmitting, to the electronic ticket management system 401, command information purporting that the electronic ticket 34 is to be collected together with the electronic ticket ID 701 and causing the electronic ticket management system 401 in receipt of the command information to make the electronic ticket 34 in the electronic ticket DB 16 collected by using the electronic ticket key ID 701 as key so as to prevent the electronic ticket 34 from being used since then. The mobile service terminal 603 deletes the electronic ticket 34 in the IC card 35 and returns the IC card 35 by way of the IC card reader/writer 605. The door-to-door courier service person 609 returns the IC card 35 to the exhibitor and after receiving the exhibiting article 31, leaves the exhibitor dwelling.

In the examples set forth so far, the exhibitor forwards the exhibiting article 31 after confirming that the bidder transfers the bill and the electronic ticket 34 for exhibitor is collected after the exhibiting article 31 has been forwarded. But when the bidder pays the charge to the exhibitor after receiving the exhibiting article 31, the procedure is needed in which the forwarding date of the exhibiting article 31 is written in the object forwarding column 712 in the electronic ticket 34 for exhibitor without collecting the electronic ticket 34 for exhibitor and the IC card 35 is then returned to the exhibitor. In the event that the money is not paid later, the sales contract settlement and finished forwarding of the article can be confirmed from the contents of records in the electronic ticket 34 and electronic ticket DB 16 and therefore the wrongdoing can be detected.

FIG. 8 shows an example of data in electronic ticket information 800 accumulated in the electronic ticket DB 16 annexed to the trade mediating mechanism computer 1 of the invention. There is depicted an example which includes, as electronic ticket information, past transaction total money amount column 806 (1285000 yen) and past transaction frequency column 807 (13 times) in addition to the article price column 810 (15000 yen).

FIGS. 9A and 9B show the discount service (rate) in accordance with utilization conditions of the trade mediating system of the invention. In an example shown in FIG. 9A, a table is prepared which changes the discount rate in correspondence with the past transaction frequency and in an example shown in FIG. 9B, a table is prepared which changes the discount rate in correspondence with the past total transaction money amount. In the case of the electronic ticket information 800, the past transaction frequency is 13 times and so the reduction rate is 10% and the past transaction total money amount is 1285000 yen and so the reduction rate is 15%. If a larger discount rate is adopted, the discount rate 15% is applied in the case of electronic ticket information 800. By recording the past transaction total money amount and the past transaction frequency on the electronic ticket in this manner, elaborate discount service can be presented in the trade mediating system.

According to the invention, in the inter-individual trade mediating system such as the auction system or trade information billboard system using the network, service for reducing the bill payment and article forwarding charge after a trade contract has been settled can advantageously be offered through the electronic procedures only. Further, the banking organ and delivery service dealer can expect that the trade mediating system is utilized by many and unspecified users and therefore, the number of users can be increased meritoriously.

It should be further understood by those skilled in the art that although the foregoing description has been made on embodiments of the invention, the invention is not limited thereto and various changes and modifications may be made without departing from the spirit of the invention and the scope of the appended claims.

1. A trade mediating mechanism computer for use in a trade mediating system for making a contract of trade of an article between individuals through a network, comprising:
page generation and management means for generating and managing a page for trade mediation by utilizing an article registration database and a user database; and
electronic ticket management/issue/collection means for performing management, issue, authentication, and collection of an electronic ticket by utilizing an electronic ticket DB,
wherein said trade mediating mechanism computer issues electronic tickets including discount information to an exhibitor terminal and a bidder terminal when a sales contract is settled, and when receiving a check of the electronic ticket from a banking organ computer or transportation mechanism computer, said trade mediating mechanism computer causes said electronic ticket management/issue/collection means to authenticate the electronic ticket and return an authentication result.

2. A trade mediating mechanism computer according to claim 1, wherein purchaser information such as individuality authentication ID, purchase article name, purchase price and door-to-door courier service dealer is recorded on the electronic ticket, and the information and the authentication function of said electronic ticket management/issue/collection means are used to electronically certify the validity of the electronic ticket.

3. A trade mediating mechanism computer according to claim 2, wherein a discount rate corresponding to a past transaction frequency or a past transaction total money amount in said trade mediating system is adopted as said discount information, and the discount rate is increased stepwise in accordance with magnitude of the frequency or the total money amount.
